(19) United States
(12) Patent Application Publication
(10) Pub. No.: US 2006/0085315 A1
(43) Pub. Date: Apr. 20, 2006

(54) Financial institution channel cooperation system, channel cooperating apparatus, and channel control apparatus

(75) Inventor: Emiko Sugano, Saitama (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/249,382

(22) Filed: Oct. 14, 2005

(30) Foreign Application Priority Data
Oct. 15, 2004 (JP) 2004-302102

(51) Int. Cl. G06Q 40/00

(52) U.S. Cl. 705/35

(57) ABSTRACT

A financial institution channel cooperation system which connects a plurality of channels among delivery channels and supply channels of a financial institution includes: a channel control apparatus installed in a delivery channel element apparatus; and a channel cooperating apparatus which encloses the channel control apparatus and can be connected to an upper apparatus or an external apparatus. The channel cooperating apparatus includes: a communication control unit which absorbs a difference between communication protocols of channels; a workflow defining unit in which a definition of a workflow in which many channels cooperate has been stored; a workflow processing unit in which a work program as a processing unit has been stored and which processes an instruction work; and a workflow control unit which executes the requested defined workflow.

### BACKGROUND OF THE INVENTION

1. Field of the Invention

The invention relates to a financial institution channel cooperation system, an individual channel cooperating apparatus, and an individual channel control apparatus and, more particularly, the invention intends to provide a mechanism which can generally execute processes which are cooperatively executed among a plurality of channel processing apparatuses.

2. Related Background Art

Elements of a financial system in a financial institution including a bank can be mainly classified into two channels: a supply channel as a providing source of a product or services and a delivery channel for providing a product or services to the office clerk of the financial institution or the user of the financial institution at this time.

As examples of the supply channel, a host computer in an own corporation, a business system such as a business server or the like, a providing system of a financial product or financial services which are provided by an external enterprise, and the like can be mentioned. As examples of the delivery channel, a service office terminal, an ATM, an Internet banking using the Internet, a telephone banking using a telephone, and the like can be mentioned.

In the conventional financial system, it is presumed to provide the product or services which are provided by the supply channel to the delivery channel, and generally, a connection between the supply channel and the delivery channel is independent every business. Hitherto, a connection between the delivery channels is not considered because the connection between the system of the supply channel and the system of the delivery channel is presumed. In the conventional financial system, therefore, if it is intended to introduce a new business, a dedicated apparatus such as a dedicated terminal or the like has to be installed every business.

To solve such a problem, one terminal has terminal functions of a plurality of servers (servers regarding the supply channel) or an intermediate server for a delivery channel terminal (hereinafter, referred to as a channel server) is arranged between of the supply channel and the delivery channel and various businesses are collected and provided to the terminal by the channel server. A server for the service office terminal, a Web server for the Internet banking, and the like can be mentioned as examples of the channel server.

Further, in recent years, such a business process between the delivery channels that consultation time/date at a service office counter is reserved through the Internet or the like becomes necessary. Such a cooperating process between the delivery channels is a use form which is not presumed in the present financial system. In order to realize the cooperating process between the delivery channels, a system is individually developed at present every application.

In recent years, in the financial institution, a method of performing sales by effectively utilizing the delivery channel which makes a contact with the customer in order to sell a new product, provide services, or enhance a sales power, or the like, has become necessary due to the financial deregulation of the bank counter sales or the like of an insurance or securities. According to the conventional method, it is necessary to individually develop the system each time new needs or a new business such as a cooperation between the channels or the like occurs, so that there is a problem that en efficiency is very low.

In the financial institution, it is demanded to enhance the compliance. As a measure for such a demand, it is necessary to record and monitor the accomplishment of the business in accordance with the business regulation. According to the conventional method, although the accomplishment of the special business can be recorded, it is difficult to record a combination of several businesses or a business over the delivery channels.

Therefore, a financial institution channel cooperation system, a channel cooperating apparatus, and a channel control apparatus which can flexibly and efficiently cope with a cooperating process between channels that is necessary when a new product or services are provided, or the like, are demanded.

### SUMMARY OF THE INVENTION

It is an object of the invention to provide a financial institution channel cooperation system, a channel cooperating apparatus, and a channel control apparatus which can generally execute processes which are cooperatively executed among a plurality of channel processing apparatuses.

According to the present invention, there is provided a financial institution channel cooperation system connecting a plurality of channels among delivery channels and supply channels of a financial institution, comprising:

channel control apparatuses set in a delivery channel element apparatus; and

a channel cooperating apparatus which encloses one or a plurality of the channel control apparatuses therein and can be connected to an upper apparatus or an external apparatus,

wherein the channel cooperating apparatus has

a communication control unit which absorbs a difference between communication protocols of channels,

a workflow defining unit in which a definition of a workflow in which a plurality of the channels cooperate has been stored,

a first workflow processing unit in which one or a plurality of work programs as a processing unit that can construct a part of the workflow has/have been stored and which processes an instruction work, and

a workflow control unit which executes the processing-requested defined workflow.

In the financial institution channel cooperation system, all or a part of the channel control apparatuses have a workflow process requesting unit which sends identification information of the workflow to the channel cooperating apparatus and requests it to execute the workflow.

Moreover, in the financial institution channel cooperation system, all or a part of the channel control apparatuses have a second workflow processing unit in which one or a plurality of work programs as a processing unit that can construct a part of the workflow has/have been stored and which processes an instruction work from the workflow control unit of the channel cooperating apparatus.

Moreover, in the financial institution channel cooperation system, the channel cooperating apparatus further has a workflow execution history unit in which execution history information regarding a work is written by the workflow control unit when the work is started and finished.

Further, according to the present invention, there is provided a channel cooperating apparatus which constructs a financial institution channel cooperation system connecting a plurality of channels among delivery channels and supply channels of a financial institution together with channel control apparatuses set in a delivery channel element apparatus, encloses one or a plurality of the channel control apparatuses, and can be connected to an upper apparatus or an external apparatus, comprising:

a communication control unit which absorbs a difference between communication protocols of channels;

a workflow defining unit in which a definition of a workflow in which a plurality of the channels cooperate has been stored;

a first workflow processing unit in which one or a plurality of work programs as a processing unit that can construct a part of the workflow has/have been stored and which processes an instruction work; and

a workflow control unit which executes the processing-requested defined workflow.

Moreover, the financial institution apparatus may further comprise a workflow execution history unit in which execution history information regarding a work is written by the workflow control unit when the work is started and finished.

Furthermore, according to the present invention, there is provided a channel control apparatus as a component element of a financial institution channel cooperation system which has channel control apparatuses set in a delivery channel element apparatus and a channel cooperating apparatus that encloses one or a plurality of the channel control apparatuses and can be connected to an upper apparatus or an external apparatus and which connects a plurality of channels among delivery channels and supply channels of a financial institution,

wherein the enclosed channel cooperating apparatus comprises:

a communication control unit which absorbs a difference between communication protocols of channels;

a workflow defining unit in which a definition of a workflow in which a plurality of channels cooperate has been stored;

a first workflow processing unit in which one or a plurality of work programs as a processing unit that can construct a part of the workflow has/have been stored and which processes an instruction work;

a workflow control unit which executes the processing-requested defined workflow; and

a workflow process requesting unit which sends identification information of the workflow to the channel cooperating apparatus and requests it to execute the workflow.

Moreover, the channel control apparatus may further comprise a second workflow processing unit in which one or a plurality of work programs as a processing unit that can construct a part of the workflow has/have been stored and which processes an instruction work from the workflow control unit of said channel cooperating apparatus.

According to the invention, the financial institution channel cooperation system, channel cooperating apparatus, and channel control apparatus which can flexibly and efficiently cope with such a cooperating process between the channels that is necessary when a new product or services are provided, or the like, can be provided.

The above and other objects and features of the present invention will become apparent from the following detailed description and the appended claims with reference to the accompanying drawings.

### BRIEF DESCRIPTION OF THE DRAWINGS

FIG. 1 is a block diagram showing a functional construction of a financial institution channel cooperation system of an embodiment;

FIG. 2 is a block diagram showing an example of a financial system to which the financial institution channel cooperation system of the embodiment is applied;

FIG. 3 is a flowchart generally showing the operation of a workflow control unit of the embodiment;

FIG. 4 is a block diagram showing a functional construction of the financial institution channel cooperation system from a viewpoint of the first specific example of workflow definition of the embodiment;

FIG. 5 is an explanatory diagram showing the first specific example of definition of the workflow of the embodiment;

FIG. 6 is a flowchart showing processes when the first specific example of the workflow definition of the embodiment is executed; and

FIG. 7 is an explanatory diagram showing the second specific example of the workflow definition of the embodiment.

### DETAILED DESCRIPTION OF THE PREFERRED EMBODIMENTS

### (A) Embodiment

An embodiment of a financial institution channel cooperation system, a channel cooperating apparatus, and a channel control apparatus according to the invention will be described in detail hereinbelow with reference to the drawings.

### (A-1) Construction of Embodiment

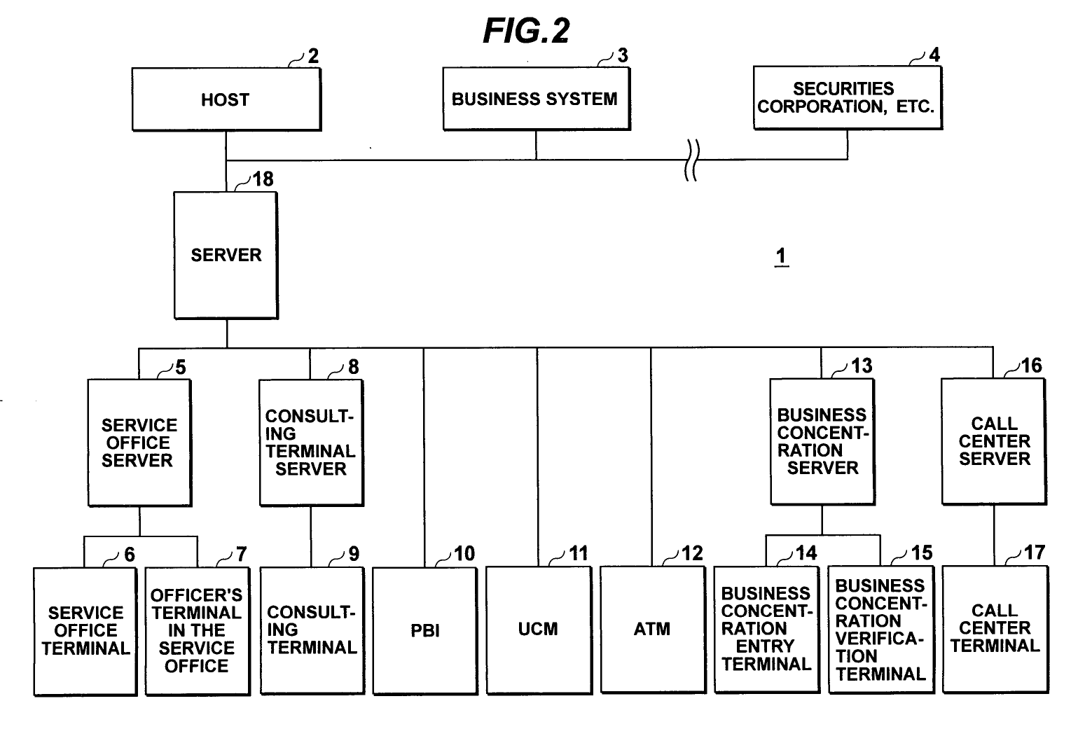

FIG. 2 is a block diagram showing an example of a layered construction of a financial system to which the financial institution channel cooperation system of the embodiment is applied. The financial institution used here denotes, for example, a bank.

In FIG. 2, a financial system 1 has the following supply channel elements: a host computer 2; a business system 3 such as a business server or the like; a providing system 4 of a financial product or financial services which are supplied by an external enterprise (for example, securities corporation); and the like.

The financial system 1 has the following delivery channel elements: a service office terminal 6 and an officer's terminal 7 in the service office which are enclosed in a service office server 5 as a channel server; a consulting terminal 9 enclosed in a consulting terminal server 8 as a channel server; a passbook bond issuing machine (PBI) 10; a united cash processing machine (UCM) 11; an ATM 12; a business concentration entry terminal 14 and a business concentration verification terminal 15 which are enclosed in a business concentration server 13 as a channel server provided in a business concentration center; a call center terminal 17 enclosed in a call center server 16 as a channel server provided in a call center; and the like.

Further, the financial system 1 has a connection server 18 existing for connection between the supply channel elements and the delivery channel elements or between the delivery channel elements.

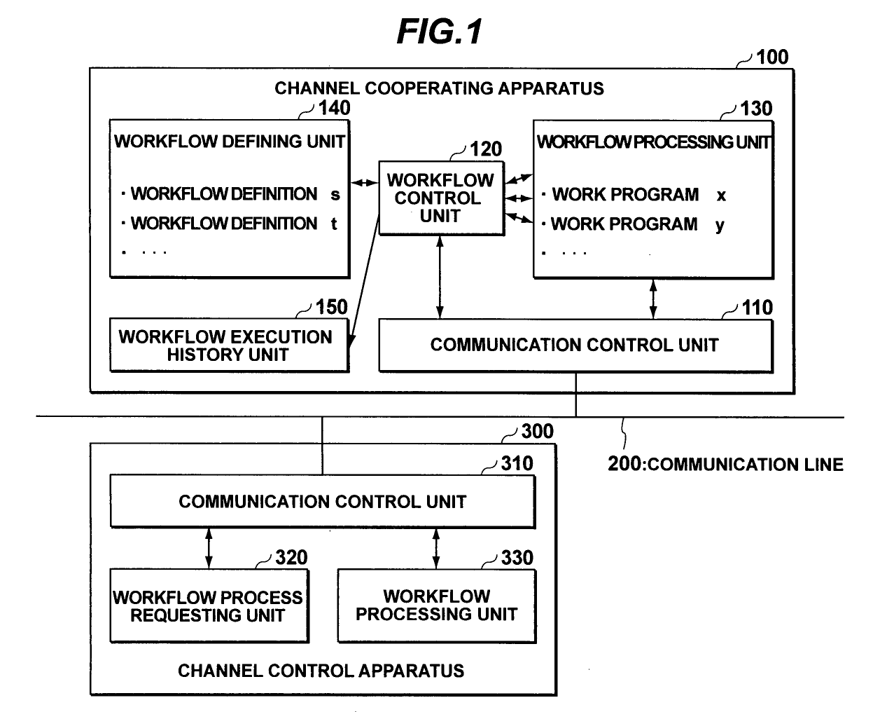

As will be explained hereinafter, the financial institution channel cooperation system of the embodiment has a channel cooperating apparatus and a channel control apparatus as component elements (refer to FIG. 1). The channel cooperating apparatus is installed in, for example, the connection server 18. The channel control apparatus is installed in, for example, the service office server 5, consultation server 8, ATM 12, business concentration server 13, call center server 16, or the like. Hitherto, the connection server 18 functioned as a gateway server. In the embodiment, it also functions as a channel cooperating apparatus. Instead of the gateway server, the connection server 18 can be also provided as a server which operates as a dedicated channel cooperating apparatus.

FIG. 1 is a block diagram showing a functional construction of the financial institution channel cooperation system of the embodiment.

As shown in FIG. 1, in the financial institution channel cooperation system of the embodiment, a channel cooperating apparatus 100 and one or a plurality of channel control apparatuses 300 are connected through a communication line 200. As a communication line 200, a plurality of communication lines such as line for the delivery channel, line for the supply channel, and the like can also exist in accordance with each object.

The channel cooperating apparatus 100 executes a work program thereon or work programs on various channel control apparatuses 300 on the basis of a pre-defined workflow by a processing request from the channel control apparatus 300, timing for arrival of pre-registered time/date (such a regular time process is also incorporated in the concept of the processing request in the scope of claims), or a processing request from a workflow control unit 120 of the channel cooperating apparatus 100.

The channel cooperating apparatus 100 is realized, for example, on a server with a general construction and functionally has: a communication control unit 110; the workflow control unit 120; a workflow processing unit 130; a workflow defining unit 140; and a workflow execution history unit 150.

The communication control unit 110 controls communication of information with a communication control unit 310 on each channel control apparatus 300 which is executed through the communication line 200. When each channel control apparatus 300 performs the communication by a peculiar communication protocol or a communication data format, the communication control unit 110 executes conversion or the like of the communication protocol or the communication data format so that the information can be processed by the channel cooperating apparatus 100. For example, even if the communication protocol or the communication data format of the channel control apparatus 300 installed in the service office server 5 in FIG. 2 differs from that of the channel control apparatus 300 installed in the ATM 11, the information can be similarly processed in the channel cooperating apparatus 100 by the function of the communication control unit 110.

That is, the communication control unit 110 has respective correspondence conversion processing portions to correspond to each channel control apparatus 300. Each correspondence conversion processing portion performs a function to execute the conversion of communication protocol or communication data format between corresponding channel control apparatus 300 and the channel cooperating apparatus 100.

The conversion of the communication protocol or the communication data format can be realized by, for example, preparing the corresponding program every communication protocol or every communication data format. When the channel cooperating apparatus 100 receives the data, after the data is received by the corresponding program, it is converted into the common data format. In the case of transmitting the data from the channel cooperating apparatus 100 to the channel control apparatus 300, the common data format is converted into the protocol of the transmitting destination or the like by the corresponding program and such a protocol is transmitted.

The workflow control unit 120 controls the execution of a series of work programs constructing the target workflow in accordance with a predetermined workflow definition.

Various work programs x, y, . . . which are called from the workflow and executed have been stored in the workflow processing unit 130 and the work is processed. A certain workflow can be specified so as to include such one or a plurality of kinds of work programs. The work programs x, y, . . . stored in the workflow processing unit 130 are not limited to the work programs which are applied to one workflow but have been described as general programs which can be applied to a plurality of workflows.

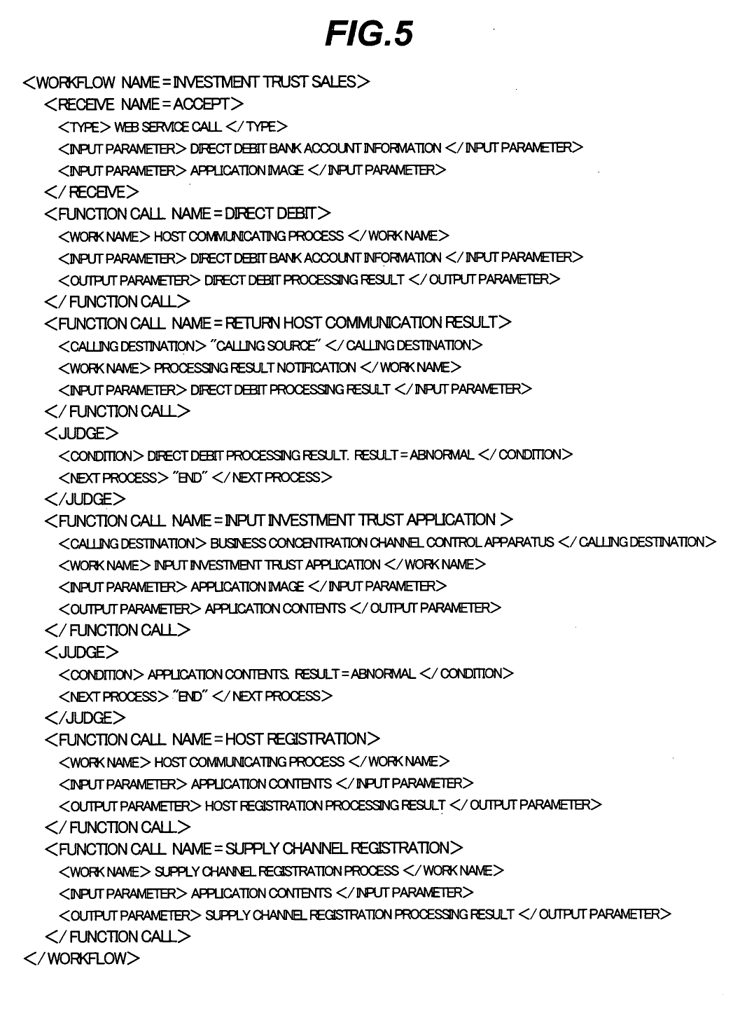

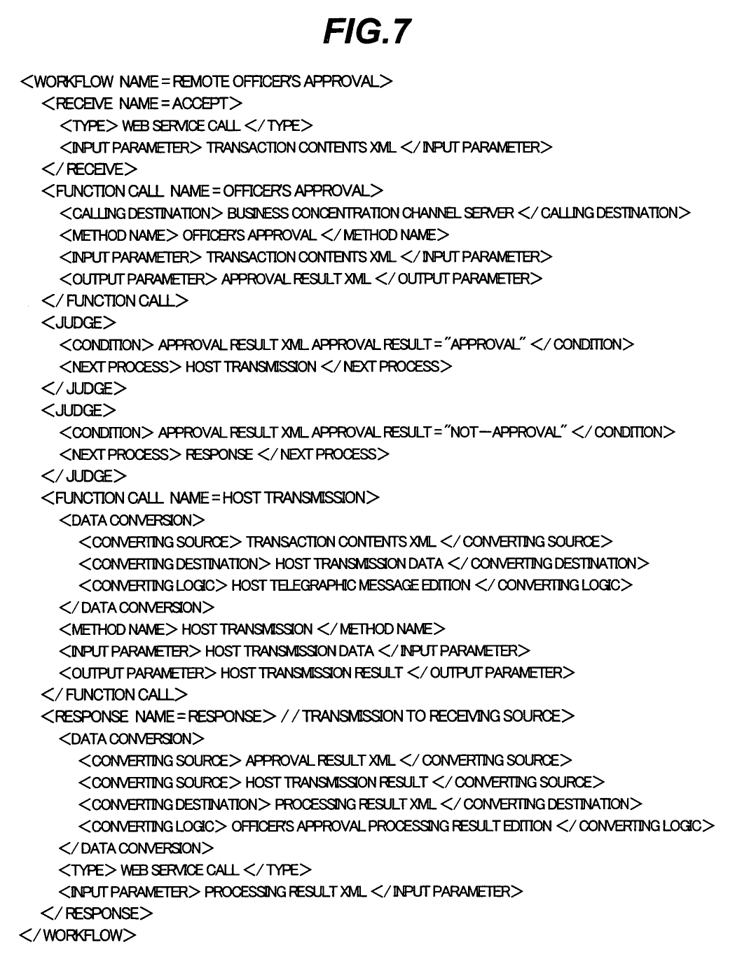

One or a plurality of workflow definitions s, t, . . . have been stored in the workflow defining unit 140. The work program which is called from the workflow, its calling destination designation, and an executing order of the work programs have been described in each workflow definition. Examples of the workflow definitions will be described hereinafter (refer to FIGS. 5 and 7).

The workflow execution history unit 150 records start information and end information of the process which is called from the defined workflow.

The channel control apparatus 300 controls the delivery channel elements such as service office terminal, ATM, and the like and, further, requests the channel cooperating apparatus 100 to process the workflow. The channel control apparatus 300 also executes the process, as a part of the workflows, which is peculiar to the channel and is called from the workflow execution of the channel cooperating apparatus 100.

The channel control apparatus 300 is constructed mainly by: for example, a CPU in the service office terminal, ATM, or the like in which its own apparatus 300 has been installed; a program which is executed by the CPU; and the like. As functional elements, the channel control apparatus 300 has the communication control unit 310, a workflow process requesting unit 320, and a workflow processing unit 330.

The communication control unit 310 controls communication of the information with the channel cooperating apparatus 100 through the communication line 200. Even if the communication protocol or the like differs from that as a reference on the channel cooperating apparatus 100 side, since the communication control unit 110 of the channel cooperating apparatus 100 absorbs its difference as mentioned above, the communication control unit 310 of the channel control apparatus 300 executes the communication control without being conscious of the fundamental communication protocol or the like.

The workflow process requesting unit 320 requests the channel cooperating apparatus 100 to process a predetermined workflow by an instruction of the operator or by activating a predetermined program installed in its own apparatus.

The work program which is called from the workflow of the channel cooperating apparatus 100 and executed has been stored in the workflow processing unit 330. The workflow processing unit 330 properly executes such a work program. The work program stored in the workflow processing unit 330 differs in dependence on the delivery channel element in which the channel control apparatus 300 has been installed.

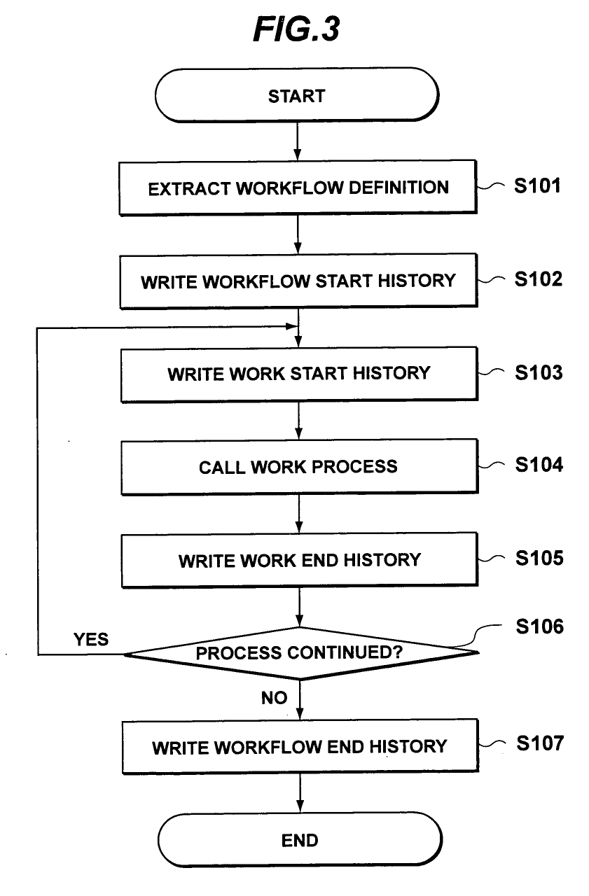

The general operation of the financial institution channel cooperation system constructed as mentioned above will now be described with reference to a flowchart of FIG. 3. FIG. 3 shows processes of the workflow control unit 120.

Each workflow is identified by an identifier (hereinafter, referred to as a workflow identifier). The processing request of the workflow to the channel cooperating apparatus 100 is made by designating the workflow identifier. The processing request can be manually or automatically made by the channel control apparatus 300, can be made by another workflow in the channel cooperating apparatus 100, or can be also automatically made when the time/date which has previously been registered comes.

When the workflow control unit 120 of the channel cooperating apparatus 100 receives the workflow processing request, it extracts the workflow definition designated by the workflow identifier from the workflow defining unit 140 and starts the execution of the workflow (step S101). The workflow control unit 120 records workflow start time information and the workflow identifier into the workflow execution history unit 150 (S102).

After that, the workflow control unit 120 starts the processes of each work constructing the workflow. In the processes of each work, first, the workflow control unit 120 records the start time information and the name of the process of the work to be executed (S103). Subsequently, the workflow control unit 120 executes processes of the designated work (S104).

The calling destination has been defined in the work. On the basis of this definition, it is necessary to request the work program of the workflow processing unit 130 of the channel cooperating apparatus 100 to execute the processes or to request the work program of the workflow processing unit 330 of the channel control apparatus 300 to execute the processes.

The process for requesting to the calling destination to execute the processes on the basis of a result of an analysis of the calling destination can be executed by the workflow control unit 120 of the channel cooperating apparatus 100, by the work program of the workflow processing unit 130, or by the communication control unit 110. By making the processing request to the calling destination in step S104, the workflow control unit 120 realizes the execution of the processes of the calling destination work program based on the analysis result of the calling destination of the work. Explanation will be made here on the assumption that the process to make the processing request to the calling destination of the work based on the analysis result of the calling destination is executed in the workflow control unit 120.

If the work program to be processed is the work program of the channel cooperating apparatus 100, the workflow control unit 120 executes such a work program. If the work program to be processed is the work program on the channel control apparatus 300, the workflow control unit 120 requests the corresponding channel control apparatus 300 to execute the processes of the work program through the communication control unit 110. In this instance, the channel control apparatus 300 receives the processes through the communication control unit 310, executes the corresponding work program of the workflow processing unit 330, and returns an execution result to the channel cooperating apparatus 100 as a requesting source.

After the work process, the workflow control unit 120 records the processing result and the end time information into the workflow execution history unit 150 (S105). Subsequently, on the basis of the processing result and the workflow definition of the work flow at this point of time, the workflow control unit 120 discriminates the presence or absence of the workflow process (work) to be executed next (S106). If the work to be processed exists, the workflow control unit 120 repeats the processes of steps S103 to S106 mentioned above.

If the work to be processed does not exist, the workflow control unit 120 records the end time information and the processing result of the workflow into the workflow execution history unit 150 (S107) and finishes the series of processes.

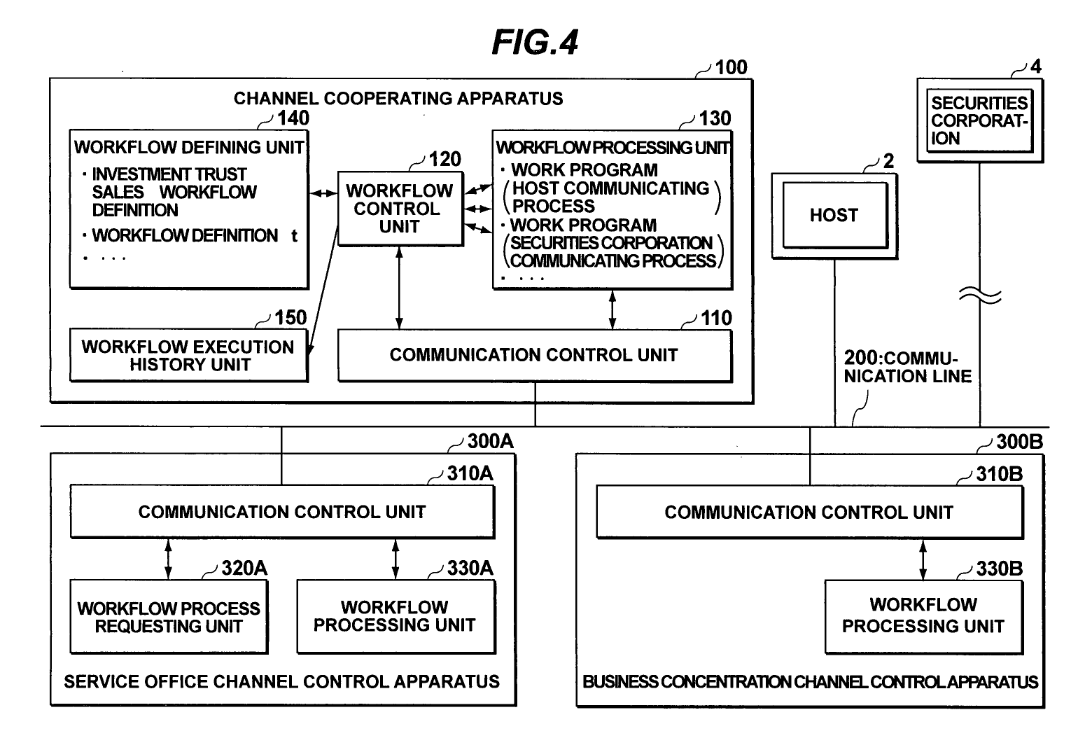

A specific example of the operation of the financial institution channel cooperation system of the embodiment will now be described also with reference to FIGS. 4 to 6.

FIG. 4 is a block diagram showing constructional elements of the system according to the specific example. The specific example is an investment trust sales workflow in which a channel control apparatus (service office channel control apparatus) 300A installed in the service office server 5 or the service office terminal 6, a channel control apparatus (business concentration channel control apparatus) 300B installed in the business concentration server 13, and the channel cooperating apparatus 100 cooperatively execute the processes. An investment trust sales workflow definition has been described in the workflow defining unit 140 of the channel cooperating apparatus 100. Work programs such as host communicating process, securities corporation communicating process, and the like which are used in the investment trust sales workflow have also been described in the workflow processing unit 130.

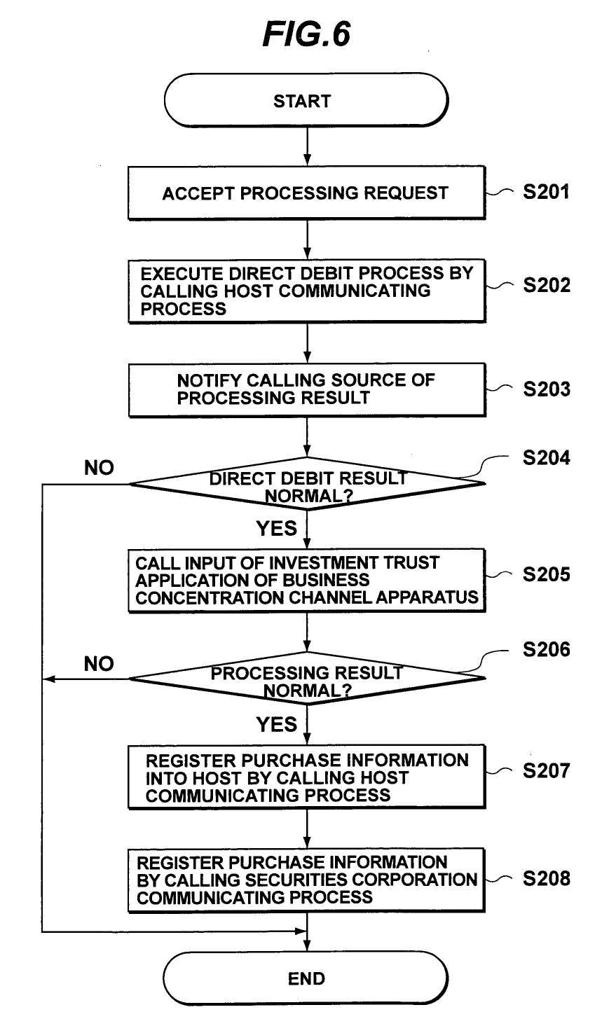

FIG. 5 shows a definition example of the investment trust sales workflow. FIG. 6 is a flowchart showing the workflow definition. In the workflow definition, works each of which has a “name” and is sandwiched between a start tag and an end tag are described in processing order. Each work is constructed by work elements comprising one or a plurality of lines each of which is sandwiched between the start tag and the end tag. Each work element specifies a value of a parameter, an attribute, or the like and specifies the program which is called from the workflow processing unit 130.

The work element sandwiched between <work name> and </work name> denotes that the program corresponding to the workflow processing unit 130 of the channel cooperating apparatus 100 or a workflow processing unit 330A or 330B of the channel control apparatus exists. If the work element sandwiched between <calling destination> and </calling destination> exists, the program corresponding to the workflow processing unit 130 of the channel cooperating apparatus 100 or the workflow processing unit 330A or 330B of the channel control apparatus 300A or 300B which is specified by such a work element exists. If the work element sandwiched between <calling destination> and </calling destination> does not exist, the program corresponding to the workflow processing unit 130 of the channel cooperating apparatus 100 exists. The work element sandwiched between <input parameter> and </input parameter> specifies the parameter which is transferred to the corresponding program or apparatus. The work element sandwiched between <output parameter> and </output parameter> specifies the parameter which is derived from the corresponding program or apparatus.

When an application for the investment trust is accepted in the service office channel, at a terminal of the service office channel, an application image is obtained, a character recognition or the like is performed, and the number (document form number) of the application is obtained. On the basis of the application number, a corresponding workflow identifier is read out of a table in which application numbers and workflow identifiers have been stored correspondingly each other. Then, the input of necessary portions is completed in order to make a payment by direct debit (deduction from a bank account of the user) of a price. After that, a workflow process requesting unit 320A of the service office channel control apparatus 300A requests the workflow control unit 120 of the channel cooperating apparatus 100 to execute processes of the workflow identifier “investment trust sales workflow”.

In this instance, the workflow control unit 120 of the channel cooperating apparatus 100 reads the corresponding workflow definition (refer to FIG. 5) on the basis of the workflow identifier “investment trust sales workflow” and executes the workflow process on the basis of the definition. The workflow whose name is “investment trust sales” is read.

The “investment trust sales workflow” is executed in accordance with the flowchart of FIG. 6. Although execution histories are obtained before and after the execution of each work, they are omitted in the following description. It is assumed that the analysis and request of the calling destination of the work are made in the workflow control unit 120.

Step S201 in FIG. 6 corresponds to the work in FIG. 5 whose start tag is <receive name=accept>. In step S201, the workflow control unit 120 calls “accept” existing in the workflow processing unit 130 of the channel cooperating apparatus 100 and stores information regarding the requesting source and input parameter information.

Step S202 in FIG. 6 corresponds to the work in FIG. 5 whose start tag is <function call name=direct debit>. In step S202, the workflow control unit 120 calls “host communicating process” existing in the workflow processing unit 130 of the channel cooperating apparatus 100, communicates with the host computer 2 by this process, and executes a process to deduct a purchase price from the bank account of the purchaser.

Step S203 in FIG. 6 corresponds to the work in FIG. 5 whose start tag is <function call name=return host communication result>. In step S203, the workflow control unit 120 calls “processing result notifying process” existing in the workflow processing unit 330A of the service office channel control apparatus 300A as a calling source. Thus, the processes of the service office server 5 or the service office terminal 6 are completed.

Step S204 in FIG. 6 corresponds to the work in FIG. 5 whose start tag is <judge> (the first one). In step S204, the workflow control unit 120 discriminates the processing result of the host communicating process of step S202. If the processing result indicates “normal”, the process is continued. If it indicates “abnormal”, the series of processes is finished.

Step S205 in FIG. 6 corresponds to the work in FIG. 5 whose start tag is <function call name=input investment trust application>. In step S205, the workflow control unit 120 calls “investment trust application inputting process” existing in the workflow processing unit 330B of the business concentration channel control apparatus 300B. In the business concentration channel (business concentration server 13), the inputting process is executed by using the business concentration entry terminal 14, the business concentration verification terminal 15, or the like and a processing result is returned.

Step S206 in FIG. 6 corresponds to the work in FIG. 5 whose start tag is <judge> (the second one). In step S206, the workflow control unit 120 discriminates the processing result of the investment trust application inputting process of step S205. If the processing result indicates “normal”, the workflow control unit 120 continues the process. If it indicates “abnormal”, the series of processes is finished.

Step S207 in FIG. 6 corresponds to the work in FIG. 5 whose start tag is <function call name=host registration>. In step S207, the workflow control unit 120 calls “host communicating process” existing in the workflow processing unit 130 of the channel cooperating apparatus 100, communicates with the host computer 2, and registers information of the purchaser into the host computer 2.

Step S208 in FIG. 6 corresponds to the work in FIG. 5 whose start tag is <function call name=supply channel registration>. In step S208, the workflow control unit 120 calls “securities corporation communicating process (supply channel communicating process)” existing in the workflow processing unit 130 of the channel cooperating apparatus 100, communicates with the service providing system 4 of the securities corporation, and registers purchase information into the securities corporation.

Since the next line is the end tag </workflow> of the workflow, the investment trust sales workflow is finished in this manner.

When the service office terminal tries to execute the processes regarding the investment trust sales in the situation where the channel cooperating apparatus does not exist, all of the programs such as a communicating process and the like with the host computer 2 or the service providing system 4 of the securities corporation have to be described in the service office terminal.

FIG. 7 shows an example of another workflow definition defined in the workflow defining unit 140 of the channel cooperating apparatus 100. FIG. 7 shows the definition example of a remote officer's approval workflow. In the case of the financial institution, the counter office clerk asks the officer for an approval in the large-amount transaction. FIG. 7 shows the case of the remote officer where the counter office clerk of the service office asks the officer of the business concentration center for an approval through a communication line. The work element in FIG. 7 whose start tag is <method name> is similar to the work element in FIG. 5 whose start tag is <work name>.

Although not shown in the flowchart, the following processes are executed in accordance with the workflow definition of FIG. 7. A storing process of the history information is omitted also in the following description. It is also assumed that the analysis and request of the calling destination of the work are made in the workflow control unit 120.

The workflow control unit 120 of the channel cooperating apparatus 100 fetches the transaction contents from the channel control apparatus 300 of the service office server 5 (or the service office terminal 6) by the accepting process, transfers them to the channel control apparatus 300 of the business concentration server 13, activates the “officer's approval” program in the channel control apparatus 300 of the business concentration server 13, and obtains an approval result.

After that, the workflow control unit 120 of the channel cooperating apparatus 100 sequentially discriminates whether or not the approval result indicates “approval”. If an affirmative result is obtained, the processing routine advances to a “host transmission” work. If a negative result is obtained, the processing routine advances to a “response” work. In the “host transmission” work, the transaction contents are converted into host transmission data by using a host telegraphic message editing logic (this converting logic can be stored in the workflow control unit 120 or can be also stored in the workflow processing unit 130), thereafter, the host transmission data is transmitted to the host computer 2, and a transmission result is obtained. In the “response” work which is executed after the “host transmission” work or executed when the approval result indicates “not-approval”, the approval result or the host transmission result is converted into the processing result to be returned to the channel control apparatus 300 of the service office server 5 (or the service office terminal 6) in accordance with an officer's approval processing result editing logic and the converted processing result is returned to the channel control apparatus 300 of the service office server 5 (or the service office terminal 6).

If it is intended to execute the remote officer's approval process between the service office server (or the service office) terminal and the business concentration server in the situation where the channel cooperating apparatus does not exist, the dedicated program regarding the remote officer's approval has to be formed and stored into each of the service office server (or the service office) terminal and the business concentration server.

According to the financial institution channel cooperation system, channel cooperating apparatus, and channel control apparatus of the embodiment, the following effects can be obtained.

According to the embodiment, various channels can be connected by the communication control unit for converting and absorbing the difference of the communication protocols between the channel control apparatuses. A combination of the business processes of the channels or their executing order can be freely changed merely by changing the workflow definition. Thus, not only the cooperating process between the channels which has conventionally been difficult to be executed can be easily realized but also it is possible to flexibly and efficiently cope with a future change in the situation where the businesses of the financial institution will be largely changed due to the financial deregulation or the like.

Further, since the workflow execution history has been obtained, whether or not the combining process of a plurality of businesses has normally been executed can be verified by discriminating the execution history, so that it is possible to make use of the invention for prevention of an illegal business process.

### (B) Other Embodiments

Although the example in which the workflow definition is successively analyzed and executed has been shown in the above embodiment, it is also possible to analyze the workflow definition prior to executing it, previously convert it into one program, and execute this program. The conversion into one program can be executed before the workflow processing request is accepted or can be also executed after the workflow processing request was accepted.

Although the example in which the operator manually confirms the execution history stored in the workflow execution history unit 150 has been shown in the above embodiment, it is also possible to provide an automatic confirmation processing unit for confirming whether or not the processes have been executed in accordance with a flow of the works in the defined workflow.

The present invention is not limited to the foregoing embodiments but many modifications and variations are possible within the spirit and scope of the appended claims of the invention.

What is claimed is:

1. A financial institution channel cooperation system connecting a plurality of channels among delivery channels and supply channels of a financial institution, comprising:
channel control apparatuses set in a delivery channel element apparatus; and
a channel cooperating apparatus which encloses one or a plurality of said channel control apparatuses therein and can be connected to an upper apparatus or an external apparatus,
wherein said channel cooperating apparatus has
a communication control unit which absorbs a difference between communication protocols of channels,
a workflow defining unit in which a definition of a workflow in which a plurality of said channels cooperate has been stored,
a first workflow processing unit in which one or a plurality of work programs as a processing unit that can construct a part of said workflow has/have been stored and which processes an instruction work, and
a workflow control unit which executes the processing-requested defined workflow.

2. The financial institution channel cooperation system according to claim 1, wherein all or a part of said channel control apparatuses have a second workflow processing unit in which one or a plurality of work programs as a processing unit that can construct a part of said workflow has/have been stored and which processes an instruction work from said workflow control unit of said channel cooperating apparatus.

3. The financial institution channel cooperation system according to claim 1, wherein said channel cooperating apparatus further has a workflow execution history unit in which execution history information regarding a work is written by said workflow control unit when said work is started and finished.

4. The financial institution channel cooperation system according to claim 1, wherein all or a part of said channel control apparatuses have a workflow process requesting unit which sends identification information of the workflow to said channel cooperating apparatus and requests it to execute the workflow.

5. The financial institution channel cooperation system according to claim 4, wherein said channel cooperating apparatus further has a workflow execution history unit in which execution history information regarding a work is written by said workflow control unit when said work is started and finished.

6. The financial institution channel cooperation system according to claim 4, wherein all or a part of said channel control apparatuses have a second workflow processing unit in which one or a plurality of work programs as a processing unit that can construct a part of said workflow has/have been stored and which processes an instruction work from said workflow control unit of said channel cooperating apparatus.

7. The financial institution channel cooperation system according to claim 6, wherein said channel cooperating apparatus further has a workflow execution history unit in which execution history information regarding a work is written by said workflow control unit when said work is started and finished.

8. A channel cooperating apparatus which constructs a financial institution channel cooperation system connecting a plurality of channels among delivery channels and supply channels of a financial institution together with channel control apparatuses set in a delivery channel element apparatus, encloses one or a plurality of said channel control apparatuses, and can be connected to an upper apparatus or an external apparatus, comprising:
a communication control unit which absorbs a difference between communication protocols of channels;
a workflow defining unit in which a definition of a workflow in which a plurality of said channels cooperate has been stored;
a first workflow processing unit in which one or a plurality of work programs as a processing unit that can construct a part of said workflow has/have been stored and which processes an instruction work; and
a workflow control unit which executes the processing-requested defined workflow.

9. The financial institution apparatus according to claim 8, further comprising a workflow execution history unit in which execution history information regarding a work is written by said workflow control unit when said work is started and finished.

10. A channel control apparatus as a component element of a financial institution channel cooperation system which has channel control apparatuses set in a delivery channel element apparatus and a channel cooperating apparatus that encloses one or a plurality of said channel control apparatuses and can be connected to an upper apparatus or an external apparatus and which connects a plurality of channels among delivery channels and supply channels of a financial institution,
wherein said enclosed channel cooperating apparatus comprises:
a communication control unit which absorbs a difference between communication protocols of channels;
a workflow defining unit in which a definition of a workflow in which a plurality of channels cooperate has been stored;
a first workflow processing unit in which one or a plurality of work programs as a processing unit that can construct a part of said workflow has/have been stored and which processes an instruction work;
a workflow control unit which executes the processing-requested defined workflow; and
a workflow process requesting unit which sends identification information of the workflow to said channel cooperating apparatus and requests it to execute the workflow.

11. The channel control apparatus according to claim 10, further comprising a second workflow processing unit in which one or a plurality of work programs as a processing unit that can construct a part of said workflow has/have been stored and which processes an instruction work from said workflow control unit of said channel cooperating apparatus.
